(19) United States
(12) Patent Application Publication
(10) Pub. No.: US 2019/0145242 A1
(43) Pub. Date: May 16, 2019

(54) SYSTEM AND METHODOLOGY FOR ESTIMATION OF OIL FORMATION VOLUME FACTOR

(71) Applicant: Schlumberger Technology Corporation, Sugar land, TX (US)

(72) Inventors: Younes Jalali, Tokyo (JP); Ryota Tonoue, Sagamihara-shi (JP); Hua Chen, Yokohama (JP); Christopher Harrison, Auburndale, MA (US); Kamal Kader, Tokyo (JP)

(21) Appl. No.: 15/810,298

(22) Filed: Nov. 13, 2017

(51) Int. Cl. E21B 47/00; E21B 49/08

(52) U.S. Cl. CPC E21B 47/0003; G01N 11/00; E21B 49/088

(57) ABSTRACT

A technique facilitates fluid analysis in situ at a downhole location. According to an embodiment, a sample of oil is obtained at the downhole location from oil in a reservoir. A downhole sampling system is used to determine contamination of the sample and to determine other selected characteristics of the sample. The data obtained is then processed to provide a formation volume factor of the oil. The testing may be performed at selected stations along the borehole to facilitate rapid development of a realistic model of fluid distribution and property variation in the reservoir, thus enabling an improved oil recovery strategy.

### BACKGROUND

Hydrocarbon fluids such as oil and natural gas are obtained from a subterranean geologic formation, referred to as a reservoir, by drilling a well that penetrates the hydrocarbon-bearing geologic formation. After a wellbore is drilled, various forms of well completion components may be installed to enable control over and to enhance efficiency of producing fluids from the reservoir. In many applications, fluid samples are taken along the wellbore to determine characteristics of the hydrocarbon fluid contained in the reservoir. The fluid samples may be tested to determine various characteristics of both the fluid and the reservoir which can be useful in optimizing production from the reservoir. Some testing is performed downhole while other samples are retrieved to the surface for laboratory analysis.

### SUMMARY

In general, a methodology and system are provided to facilitate fluid analysis in situ at a downhole location. According to an embodiment, a sample of oil is obtained from a reservoir at the downhole location in a borehole. A downhole sampling system is used to determine contamination of the sample of oil and to determine other selected characteristics of the sample. The data obtained is then processed to provide a formation volume factor of the sample of oil. The sample analysis may be performed at selected stations along the borehole to facilitate rapid development of a realistic model of fluid distribution and property variation in the reservoir, thus enabling an improved oil recovery strategy.

However, many modifications are possible without materially departing from the teachings of this disclosure. Accordingly, such modifications are intended to be included within the scope of this disclosure as defined in the claims.

### BRIEF DESCRIPTION OF THE DRAWINGS

Certain embodiments of the disclosure will hereafter be described with reference to the accompanying drawings, wherein like reference numerals denote like elements. It should be understood, however, that the accompanying figures illustrate the various implementations described herein and are not meant to limit the scope of various technologies described herein, and:

FIG. 1 is a graphical illustration showing formation volume factor behavior versus reservoir pressure, according to an embodiment of the disclosure;

FIG. 2 is a schematic illustration of an example of a well system comprising a sampling system deployed downhole in a borehole, according to an embodiment of the disclosure;

FIG. 3 is a schematic illustration of an example of a sampling system for testing fluid samples in situ within the borehole, according to an embodiment of the disclosure;

FIG. 4 is a schematic illustration of an example of a contamination monitoring module which may be employed in the sampling system, according to an embodiment of the disclosure;

FIG. 5 is a schematic illustration of an example of a microfluidic module which may be employed in the sampling system, according to an embodiment of the disclosure; and

FIG. 6 is a graphical illustration showing another example of formation volume factor behavior versus reservoir pressure, according to an embodiment of the disclosure.

### DETAILED DESCRIPTION

In the following description, numerous details are set forth to provide an understanding of some embodiments of the present disclosure. However, it will be understood by those of ordinary skill in the art that the system and/or methodology may be practiced without these details and that numerous variations or modifications from the described embodiments may be possible.

The present disclosure generally relates to a methodology and system to facilitate fluid analysis in situ at a downhole location. The methodology and system may be used for analyzing oil samples at a plurality of stations along a borehole drilled into an oil bearing formation. According to an embodiment, each sample of oil is obtained from a reservoir via a downhole sampling system deployed to desired downhole locations. The downhole sampling system may be used to determine contamination of the sample of oil. This enables compensation with respect to testing of other selected characteristics of the sample. The data obtained via the downhole sampling system is then processed to determine a formation volume factor of each sample of oil. In some applications, the testing is performed at the plurality of stations along the borehole to facilitate rapid development of a realistic model of fluid distribution and property variation in the reservoir. The model may then be used, for example, to enable creation of an improved oil recovery strategy.

The sampling system may be deployed downhole into a borehole, e.g. wellbore, as part of a well string. By way of example, the sampling system may be deployed downhole via tubing, wireline, or another suitable conveyance. According to embodiments, the sampling system is employed for downhole fluid analysis during wireline operations, while-drilling operations, or other suitable downhole operations.

In general, the sampling system may be used to obtain measurements in situ for downhole fluid analysis so as to obtain desired physical properties of reservoir fluid, e.g. physical properties which would otherwise be determined via laboratory procedures. As described in greater detail below, a desired physical property of the reservoir fluid which may be obtained via the sampling system is the formation volume factor (FVF). The FVF is the volume occupied by live oil in the reservoir which, upon production and crude separation/stabilization processes, yields one barrel of dead or degassed oil in a stock tank. Values of FVF may vary between, for example, 1.05 and 2.7 reservoir barrels per stock tank barrel.

One of the uses of this FVF property is to determine the original oil-in-place in a geological structure in terms of stock tank barrels. However, FVF also may be used to estimate the fraction of oil-in-place which would be recoverable via various recovery methods. Consequently, knowledge regarding FVF can have a direct impact on evaluation of reservoirs, production techniques, and recovery of hydrocarbons.

Traditionally, flashing of live oil samples in the laboratory was used to obtain certain physical properties of crude oil systems. The downhole sampling system described herein, however, enables the FVF to be obtained downhole and to be determined for a plurality of different stations, e.g. different stations/locations along the borehole. The FVF/property can be determined during an in situ fluid analysis job which may utilize stations where samples are taken and stations were samples are not taken. With knowledge obtained immediately from the analysis of downhole oil samples, an operator is able to develop a more realistic model of the fluid distribution and property variation (e.g. FVF variation) in the reservoir. This knowledge/model may be used to plan a more differentiated and efficient hydrocarbon recovery strategy.

As described in greater detail below, the downhole sampling system enables a methodology which uses measurements of in situ fluid analysis such as downhole spectroscopy for estimation of composition and gassiness of crude oil. The methodology also may employ measurements based on incipient flashing (not full flash to atmospheric, which may not be feasible downhole, but flashing to a bubble point pressure). The downhole sensor system may utilize a microfluidic measurement module having a depressurization chamber to determine, for example, bubble point pressure and density of the sample fluid. By using these various measurements, the FVF of the oil sample may be obtained as well as the FVF variation from initial reservoir pressure to bubble point pressure (and even below bubble point pressure) during a reservoir pressure depletion process.

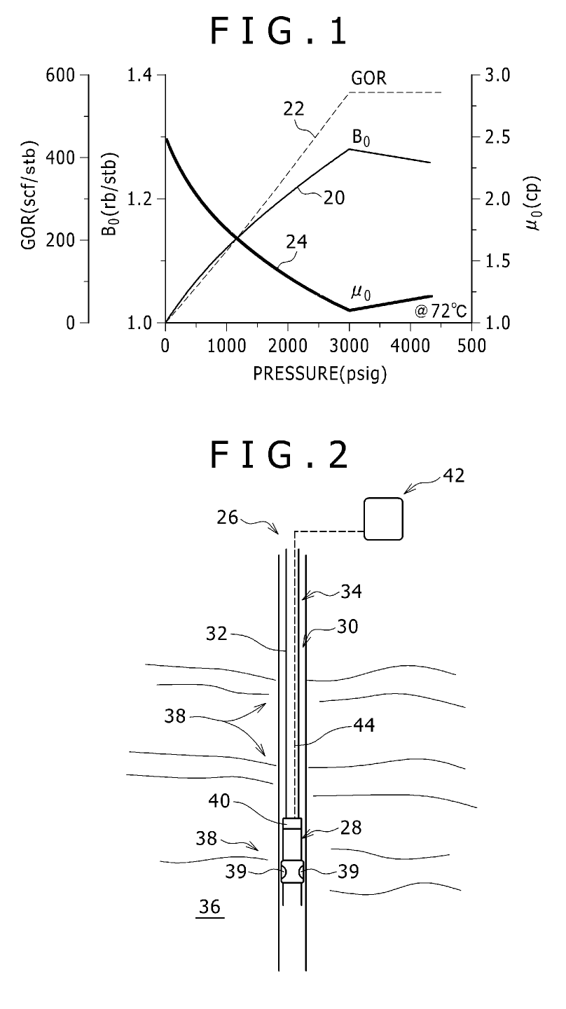

Referring generally to FIG. 1, a graphical example is provided which illustrates FVF behavior of a sample of oil (shown as Bo in the graph plot) versus reservoir pressure. In this example, a graph line 20 illustrates changes in FVF of the sample of oil as pressure changes from an initial pressure of about 4400 psi to a bubble point pressure of about 3000 psi to atmospheric pressure. As illustrated by the graph, the FVF(Bo) peaks at approximately 1.27 reservoir barrels per stock tank barrel (RB/STB) at the bubble point pressure.

A negative slope of the Bo graph line 20 at pressures above bubble point pressure indicates the crude oil in the sample is moderately compressible. At pressures below the bubble point pressure, the Bo graph line 20 tends toward unity. In the diagram illustrated, a graph line 22 is used to represent a gas to oil ratio (GOR) throughout the pressure range. Similarly, a graph line 24 is used to represent viscosity throughout the pressure range.

Referring generally to FIG. 2, an example of a well system 26 is illustrated. In this embodiment, the well system 26 comprises a sampling system 28 which may be conveyed downhole into a borehole 30, e.g. a wellbore, via a conveyance 32. The conveyance 32 may comprise tubing, e.g. production tubing or coiled tubing, wireline, or another suitable conveyance.

Additionally, the sampling system 28 and conveyance 32 may be part of an overall well string 34 having various other components selected for a given operation. For example, the well string 34 may comprise a drill string and sampling system 28 may be used to obtain well fluid samples, e.g. oil samples, during a drilling operation. The well string 34 also may be used during a wireline operation in wellbore 30 or during other types of well operations.

The sampling system 28 is moved to a desired location along borehole 30 so as to obtain a sample of fluid, e.g. oil, which enters borehole 30 from a reservoir 36 in the surrounding subterranean geologic formation. In various applications, the sampling system 28 may be moved via conveyance 32 to a plurality of different stations 38 along borehole 30 for analysis of a given fluid sample or samples. The fluid samples, e.g. oil samples, may be taken at selected stations 38 for in situ analysis at the downhole location. The sampling system 28 may comprise or work in cooperation with PVT (pressure/volume/temperature) sensors 39, e.g. pressure and temperature sensors, to monitor pressures and temperatures at the various formation stations 38.

The data obtained via the in situ analysis by sampling system 28 may be processed further to determine the desired well fluid/oil property, e.g. FVF. Processing of the data may be performed downhole, at the surface, or partially downhole and partially at the surface. In some applications, the processing may be done at least in part via a downhole processor 40 operatively coupled with sampling system 28. The sampling system 28 also may be coupled with a surface processing system 42 via a suitable telemetry system 44, e.g. a wired or wireless telemetry system. In some applications, both the downhole processor 40 and the surface processing system 42 may be utilized in processing data obtained via the in situ analysis performed by downhole sampling system 28.

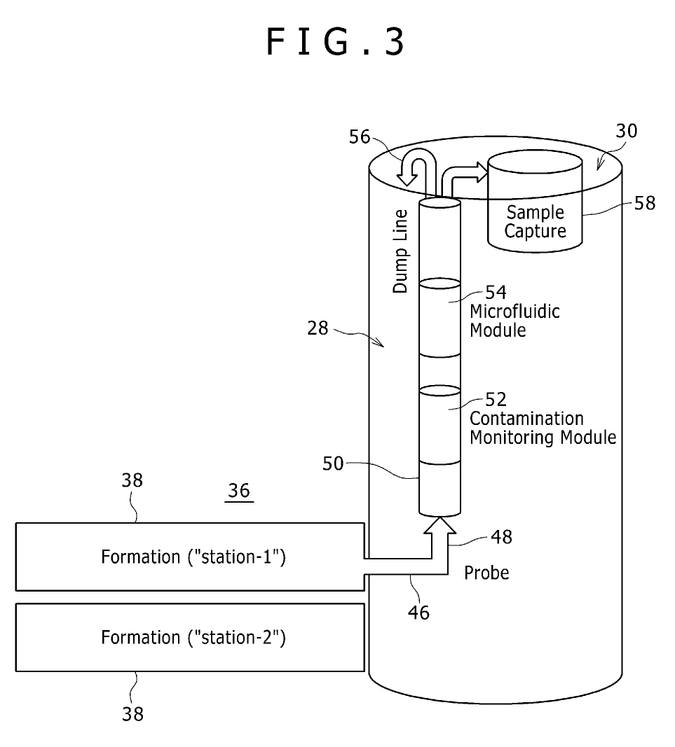

Referring generally to FIG. 3, an example of sampling system 28 is illustrated. In this embodiment, sampling system 28 is deployed in wellbore 30 proximate the first formation station 38 of a plurality of stations 38. The sampling system 28 comprises a probe 46 through which a sample of fluid 48, e.g. a sample of oil, is drawn from the surrounding formation/reservoir 36. The sample 48 flows into a sampling system structure 50, e.g. a housing or manifold, for analysis via appropriate fluid analysis modules.

The fluid analysis modules may be selected to, for example, analyze each sample 48 in situ to correct for contamination and to determine other sample characteristics, such as bubble point pressure and density. By way of example, the sampling system 28 may comprise a contamination monitoring module 52 and a microfluidic measurement module 54. In this example, each sample 48 flows through probe 46, into structure 50, and into contamination monitoring module 52 for in situ detection and correction due to contamination of the sample 48, e.g. oil sample, so as to facilitate further analysis.

In the illustrated embodiment, the sample 48 continues to flow through structure 50 and into microfluidic measurement module 54. The microfluidic measurement module 54 is then used in situ to determine other desired characteristics, e.g. bubble point pressure and density, of the sample 48 so as to enable determination of the formation volume factor and/or other desired property via the data obtained from the downhole analysis. Data resulting from the analysis at contamination monitoring module 52 and microfluidic measurement module 54 may be provided to the processing system, e.g. downhole processor 40 and/or surface processing system 42, to determine the formation volume factor and/or other desired property. In the specific example illustrated, each sample 48 may be further directed through structure 50 and flowed into, for example, a dump line 56 and/or sample capture chamber 58.

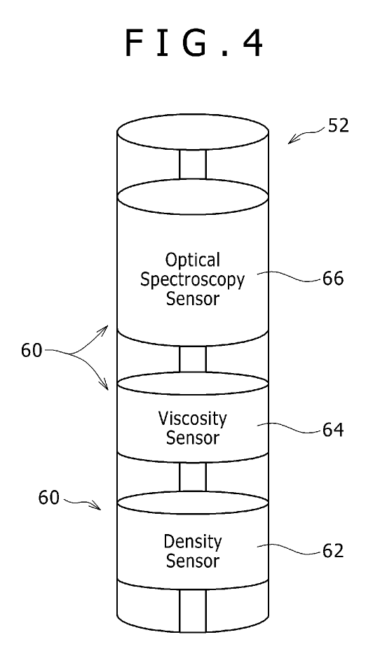

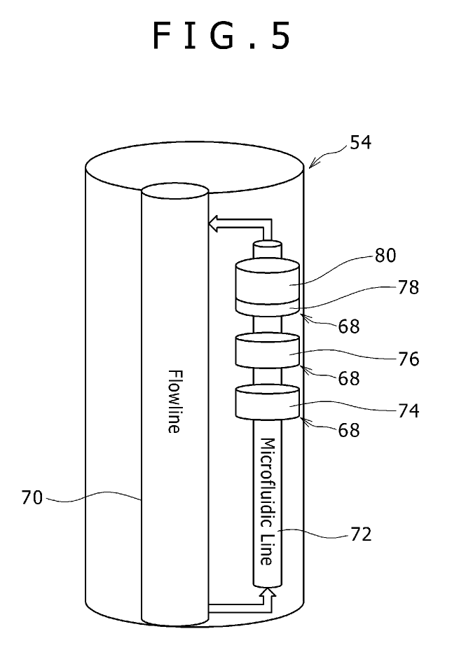

Referring generally to FIGS. 4 and 5, examples of contamination monitoring module 52 and microfluidic measurement module 54, respectively, are illustrated. As illustrated in FIG. 4, the contamination monitoring module 52 may comprise a plurality of sensors 60 arranged to detect specific characteristics of each sample 48 so as to provide data on contaminating constituents within the sample 48. By way of example, the contamination monitoring module 52 may comprise a density sensor 62, a viscosity sensor 64, and an optical spectroscopy sensor 66. These sensors 60 may be used individually or in combination to obtain data indicative of contaminants within the oil sample 48 (or other sample) obtained from the corresponding station 38. The contamination monitoring module 52 may be constructed for focused sampling, e.g. dual flowline sampling, or unfocused sampling, e.g. single flowline sampling. The embodiment illustrated shows the contamination monitoring module 52 as an unfocused sampling module with a single probe and single flowline but the module 52 may be constructed for more advanced monitoring via, for example, focused sampling with two probes and two flowlines.

As illustrated in FIG. 5, the microfluidic measurement module 54 also may comprise a variety of sensors 68 selected to obtain data which can be processed to, for example, determine the FVF of each sample 48 from selected formation stations 38. In the example illustrated, the microfluidic measurement module 54 comprises a primary flowline 70 and a microfluidic line 72 with sensors 68 disposed along the microfluidic line 72. By way of example, sensors 68 may comprise a density sensor 74, a viscosity sensor 76, and an optical spectroscopy sensor 78 which cooperates with a depressurization chamber 80. The depressurization chamber 80 may be operated to provide controlled depressurization of each sample 48, e.g. to determine bubble point pressure, during collection of data for processing via the processing system 40 and/or 42. It should be noted that sensors 60 and/or 68 also may comprise pressure and temperature sensors 39 for monitoring downhole conditions. In some applications, the pressure and temperature sensor 39 may be separate from sampling system 28 but operatively coupled with downhole processor 40 and/or surface processing system 42.

As illustrated, the sample 48, e.g. oil sample, flows from primary flowline 70, into microfluidic line 72, through sensors 68 and back into the primary flowline 70. Data obtained in situ via the flow of fluid samples through contamination monitoring module 52 and microfluidic module 54 of sampling system 28 may be processed to determine the FVF of the oil in the formation/reservoir 36. The data also may be used to determine changes in the FVF, e.g. variation of FVF over a reservoir pressure depletion cycle. A computational procedure for determining the FVF and desired changes in the FVF is provided below.

In implementing the computational procedure via, for example, downhole processor 40 and/or surface processing system 42 various common values are employed and oilfield units are used. For example, the computational procedure may be carried out with the following assumptions: standard pressure and temperature is considered 14.7 psi at 60° F. (520° R); water density at standard conditions is 62.37 lbs/ft³ (this value may be used to obtain dead oil density from oil specific gravity or from API gravity which, in one embodiment of the computational procedure/algorithm is inferred from bubble point pressure of the oil sample 48 and other parameters); air density at standard conditions is 0.076 lb/ft³; the universal gas constant is 10.73 psi·ft³/lbmole·° Rankine; the molecular weight of air is 28.9 lb/lbmole; and one barrel is 5.615 ft³.

According to this computational procedure, the volume of live oil in the reservoir (at bubble point pressure) is considered to be the sum of the volume of dead oil at bubble point pressure and the volume of dissolved gas at bubble point pressure (BPP), both at reservoir temperature. This provides the following expression:

$$Bob = \frac{\begin{matrix}dead . oil . vol ( at . BPP . \& . reservoir . temp ) + \\ dissolved . gas . vol ( at . BPP . \& . reservoir . temp )\end{matrix}}{dead . oil . vol ( stock . tank )} \qquad ( 1 )$$

With respect to the term “Bob”, the “B” is a term which represents the formation volume factor (FVF); the “o” indicates the formation volume factor is for oil; and the “b” indicates the formation volume factor is at the bubble point pressure. In other words, the term “Bob” refers to the starting point of the shrinkage process which results when live oil is brought from the reservoir 36 to the surface and stabilized in separation operations before being shipped to, for example, a sales line for delivery. The starting point of this shrinkage process is at the bubble point pressure which, for a virgin reservoir, is the lowest initial pressure encountered. The end point of this shrinkage process is when the oil is in a stock tank at a surface facility.

For purposes of the computational procedure, the dead oil volume at reservoir condition is assumed to be equal to the dead oil volume at stock tank condition. Therefore, we can assume the volume shrinkage caused by cooling of the virtual dead oil when moving from reservoir to stock tank condition is of the same order of magnitude as the volume expansion caused by the drop in pressure from bubble point pressure to atmospheric pressure. This assumption can be relaxed by introducing a tuning parameter, e.g. a minor or secondary tuning parameter, which allows the two dead oil volumes to not be identical. However, sufficient accuracy is achieved by assuming the quality of the two dead oil volumes at reservoir condition and stock tank condition. Consequently, the following expression is obtained (which indicates that “Bob” is unity plus a correction which is a volume ratio of dissolved gas at bubble point pressure to dead oil):

$$Bob = 1 + \frac{dissolved . gas . vol . at . BPP}{dead . oil . vol} \qquad ( 2 )$$

The volume ratio in the preceding equation can be rewritten as the product of a mass ratio and density ratio as follows:

$$\frac{dissolved . gas . vol . at . BPP}{dead . oil . vol} = \frac{dissolved . gas . mass}{dead . oil . mass} \frac{dead . oil . density}{dissolved . gas . density . at . BPP} \qquad ( 3 )$$

The mass ratio can be determined from compositional information. However, because our compositional measurement is made in mass terms, the composition should be corrected for contamination. It should be noted that the computational procedure may utilize various contamination corrections, such as those described herein.

Referring again to FIGS. 3 and 4, the contamination monitoring module 52 is used to collect data which may be used to enable processing of the desired contamination corrections. Hydrocarbons may be categorized according to their carbon numbers which can range from C1 to C6 and above. As a first approximation when performing a contamination correction, an assumption may be made that C1-C4 hydrocarbons end up in the gas phase and C5+ hydrocarbons end up in the oil phase. The assumption is valid if the weight of the fraction of C1-C4 which ends up in the oil phase is equivalent to the weight fraction of C5+ which ends up in the gas phase (the so-called cross terms). Because real gas-oil partition may deviate from this assumption the assumption may be tuned by using a partition coefficient: Ki=yi/xi (yi is mole fraction of component i in the gas phase; xi is mole fraction of component i in the oil phase; Ki is a function of pressure (P) and temperature (T) and overall composition, which is represented by a “convergence pressure” or Pk). Use of the partition coefficient would be a refinement and may be used as a primary tuning parameter. For now, we will proceed with the assumption that C1-C4 escapes into the gas phase while C5+ condenses into the liquid phase. Therefore, the following equation is obtained:

$$\frac{dissolved . gas . mass}{dead . oil . mass} = \frac{{\sum }_{i = 1}^{4} wi}{1 - {\sum }_{i = 1}^{4} wi} ; \\ wi is weight fraction of component i \qquad ( 4 )$$

The dissolved gas density at bubble point pressure indicated in equation (3) above may be obtained from the real gas law in lb/ft³ according to the following equation:

$$dissolved . gas . density . at . BPP = \frac{BPP \times M}{Zb \times R \times Tres {.}^{° } Rankine} \qquad ( 5 )$$

### Where:

R=10.73 psi·ft3/lbmole·° Rankine; gas constant in oilfield units;
Tres·° Rankine=Tres·° F.+460; reservoir temperature in degrees Rankine;
Zb=Zb(BPP,Tres,Composition); gas deviation factor at BPP; evaluated by Dranchuk method; (see “Calculations of Z Factors for Natural Gases Using Equations of State”, P. M. Dranchuk, J. H. Abou-Kassem; J. of Canadian Pet. Tech, July-September 1975, pp. 35-37.);

$$M = {\sum }_{i = 1}^{4} yiMi ;$$

gas molecular weight (Mi is molecular weight of each component; yi is mole fraction); and

$$yi = \frac{wi \text{/} Mi}{{\sum }_{i = 1}^{4} wi \text{/} Mi} , i = 1 , 2 , 3 , 4$$

In this computational procedure example, wi and BPP are contamination corrected values.

The dead oil density in equation (3) above may be estimated via a suitable overall method, e.g. according to two independent methods. The two independent methods may be used to determine the spread in FVF of oil at bubble point pressure referred to herein as Bob. A first of the two independent methods may be provided by the following equation:

$$dead . oil . density = \frac{GOR \times 14.7 \times Tres {.}^{°} R \times Zb}{5.615 \times BPP \times 520} [ 62.37 \times live . oil . density - dissolved . gas . density . at . BPP ] + 62.37 \times live . oil . density \qquad ( 6 )$$

For this computation, input parameters may again be contamination corrected parameters. Live oil density may be obtained via in situ PVT measurements (pressure volume temperature measurements) or through other suitable measurements obtained via sensors such as sensors 39/60. The gas oil ratio (GOR) may be obtained from data collected by contamination monitoring module 52 and from the dissolved gas density obtained via equation (5). The bubble point pressure (BPP) may be obtained from in situ PVT measurements. The Zb and Tres·° R also may be derived via equation (5).

The second of the two independent methods used to determine the spread in FVF for oil at the bubble point pressure may be provided by the following equation:

$$dead . oil . density = ( \frac{141.5}{131.5 + API} ) ( 62.37 ) ; in lb \text{/} {ft}^{3} \\ Where \text{:} \\ API = 80 log [ {( \frac{GOR}{gas . sp . gravity} )}^{0.83} ( \frac{18 \times {10}^{9.1 \times {10}^{- 4} Tres . ° F}}{BPP} ) ] \\ gas . sp . gravity = \frac{{\sum }_{i = 1}^{4} yiMi}{28.9} ; \qquad ( 7 )$$

(see equation (5) for calculation of the mole fraction yi from weight fraction wi).

This second method is based on the Chevron method published in 1947 (see “The Technology of Artificial Lift Methods”, Vol 1, p. 86, K. E. Brown, which contains the equation form of the Chevron API-BPP correlation; and see also “The Properties of Pet. Fluids”, 2^{nd} edition, p. 297, W. D. McCain Jr, which contains the graphical form of the Chevron API-BPP correlation). The Chevron method is used to estimate BPP using API gravity and other parameters. In the computational method described herein, the Chevron method may be used in the opposite sense in that knowing the contamination corrected BPP we are able to estimate API based on knowledge of other parameters. For example, API gravity may be estimated based on: BPP obtained from in situ PVT sensors 39; GOR; gas specific gravity derived from data obtained via contamination monitoring module 52; and pressure/temperature data. From the outputs of equations (4), (5), (6) and (7) an output from equation (3) may be obtained; and from the output of equation (3) the Bob of the equation (2) may be determined. The Bob of equation (1) is the single flash definition of Bob.

Furthermore, the Bo for P≥BPP can be obtained via the following equation (at reservoir temperature):

Bo=Bob[1−(P−BPP)Co]; P≥BPP (8)

In the above equation, Co (in 1/psi) is the coefficient of compressibility of oil under isothermal conditions and the value may be obtained from in situ PVT output (which uses density change with pressure to obtain the compressibility).

Additionally, the Bo for P≤BPP can be obtained via the following equation:

$$Bo = 1 + ( Bob - 1 ) ( \frac{P}{BPP} ) ; P \leq BPP \qquad ( 9 )$$

A correction may be applied to the above equation based on the coefficient of thermal expansion of the oil (thus unity becomes 1+[Tres−Tsurf][coeff·thermal·expansion]). This correction will be extremely small. It is also possible to infer a non-linear Bo below BPP using solution gas-oil-ratio (Rs) and not GOR. However, the uncertainties are generally inconsequential and do not warrant the correction. Accordingly, a linear drop of Bo from BPP to atmospheric pressure may be employed in the computational procedure.

In an operational example, appropriate input data is obtained in situ via sampling system 28 and associated sensors located downhole. The composition may comprise C1, C2, C3, C4, C5+ in weight percent hydrocarbons. As described herein, sampling system 28 may be used to determine the composition of a decontaminated sample of oil 48 via, for example, contamination monitoring module 52. If a contaminated composition were to be used, the FVF of the oil may be underestimated commensurate with the contamination, thus overestimating the oil-in-place. Because the composition of the oil samples 48 may be provided with greater granularity (e.g. C1, C2, C3, C4, C5, C6+), the composition can easily be converted to the above (C5+) format. The greater granularity may be useful for application of a primary tuning parameter, e.g. partition coefficient. It should be noted that if the composition of the oil sample is provided in mole percent (e.g. if published lab data is to be analyzed via the computational procedure provided herein) the molecular weight of the lumped or pseudo-component may be used.

The sampling system 28 also may be used to obtain other input data such as contamination corrected properties, e.g. BPP, GOR, live oil density. Pressure data also may be used if the live oil density is not measured at bubble point pressure. Temperature at which the bubble point pressure is measured also may be added to the input data along with Co (compressibility).

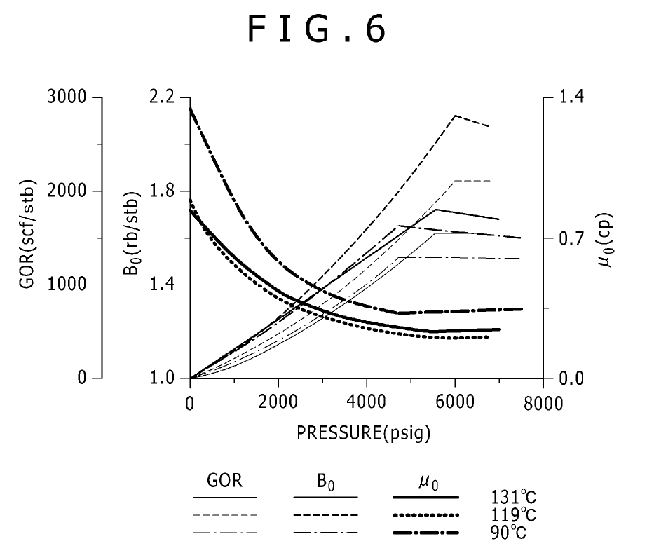

Referring generally to FIG. 6, a graphical example is provided of FVF of oil (Bo) from a first oil field (solid line) and from two other oil fields (dashed lines). The graphical example was derived based on the computational technique described herein. In this specific example, the data subjected to the computational procedure to provide the formation volume factor (Bo) over a range of pressures was determined based on the following data:
Composition [C1, C2, C3, C4, C5+] in wt %: 10.38, 1.00, 0.80, 0.50, 87.32.
GOR=1600 scf/STB; BPP=5400 psi; API=36 (so no live oil density is used in this case); gas sp. gravity=0.68 (matching this gave the distribution of C1 to C4); T=131° C.=268° F.=728° R; Bob=1.72 RB/STB; compressibility (not given, though can be inferred from the negative slope); here we can compute Bob.

$$Dissolved gas mass fraction = {\sum }_{i = 1}^{4} wi = 0.1038 + 0.0100 + 0.0080 + 0.0050 = 0.1268$$

Dead oil mass fraction=1−0.1268=0.8732

Dead oil density (obtained directly from API gravity)=[141.5/(131.5+36)]*62.37=52.7 lb/ft3

Dissolved gas density at BPP=(5400*0.68*28.9)/(1.1*10.73*728)=12.4 lb/ft³; Zb is taken to be 1.1.

Bob=1.0+(0.1268/0.8732)(52.7/12.4)=1.62 RB/STB (i.e. 1.62 reservoir barrels/stock tank barrels).

Such data may be obtained via sampling system 28 and via appropriate processing of the data obtained via sampling system 28 according to the equations described above.

Depending on the parameters of a given application and/or environment, the sampling system 28 may comprise a variety of structures and components. For example, the sampling system 28 may comprise various modules for obtaining the desired data used to enable the downhole fluid analysis and the computational procedure described herein. In some embodiments, the sampling system 28 comprises contamination monitoring module 52 to facilitate determination of a decontaminated oil sample. Additionally, the contamination monitoring module 52 may comprise a variety of sensors able to obtain the desired data for processing to effectively determine a contamination corrected oil sample.

Similarly, the microfluidic module 54 may comprise a variety of sensors to obtain the desired data used to compute the FVF of the oil and/or other desired properties. Module 52 and/or module 54 may comprise or may work in cooperation with pressure and temperature sensors 39. The sampling system 28 also may be used with a variety of well strings 34 and other well systems. The data obtained and analyzed via sampling system 28 may be further processed according to the algorithms and computational methodology described herein at a suitable downhole and/or surface location.

Although a few embodiments of the disclosure have been described in detail above, those of ordinary skill in the art will readily appreciate that many modifications are possible without materially departing from the teachings of this disclosure. Accordingly, such modifications are intended to be included within the scope of this disclosure as defined in the claims.

What is claimed is:

1. A method for downhole fluid analysis, comprising:
deploying a sampling system downhole in a borehole located within a reservoir containing oil;
using the sampling system to obtain samples of the oil at a plurality of stations along the borehole;
analyzing each sample of oil in situ to correct for contamination;
further analyzing each oil sample in situ to determine bubble point pressure and density of each oil sample; and
processing the data obtained to determine a formation volume factor (FVF) of oil in the reservoir.

2. The method as recited in claim 1, wherein analyzing comprises using a contamination monitoring module of the sampling system.

3. The method as recited in claim 2, wherein further analyzing comprises using a microfluidic measurement module.

4. The method as recited in claim 3, wherein using the contamination monitoring module comprises using an optical spectroscopy sensor, a viscosity sensor, and a density sensor.

5. The method as recited in claim 4, wherein using the microfluidic measurement module comprises placing each oil sample in a depressurization chamber.

6. The method as recited in claim 1, wherein processing comprises determining variations in FVF as the pressure on the oil varies from an initial reservoir pressure to a bubble point pressure.

7. The method as recited in claim 1, wherein further analyzing comprises incipient flashing of each sample within the borehole.

8. A method, comprising:
obtaining a sample of oil from a reservoir at a downhole location in a borehole;
using a contamination monitoring module and a microfluidic measurement module at the downhole location to obtain data on the sample of oil; and
processing the data obtained downhole to determine an FVF of oil from which the sample of oil is obtained.

9. The method as recited in claim 8, wherein obtaining comprises obtaining a plurality of samples of oil at a plurality of stations along the borehole.

10. The method as recited in claim 8, wherein using comprises using sensors in the contamination monitoring module to determine optical spectroscopy, viscosity, and density of the sample of oil.

11. The method as recited in claim 8, wherein using comprises using sensors in the microfluidic measurement module to determine optical spectroscopy, viscosity, and density of the sample of oil.

12. The method as recited in claim 11, wherein using the microfluidic measurement module further comprises depressurizing the sample of oil in a depressurization chamber to determine bubble point pressure.

13. The method as recited in claim 8, wherein processing comprises processing the data at a downhole location.

14. The method as recited in claim 8, wherein processing comprises using the FVF to determine original oil-in-place in a geological structure.

15. The method as recited in claim 8, wherein processing comprises determining variations in the FVF from initial reservoir pressure to bubble point pressure.

16. The method as recited in claim 8, wherein using comprises obtaining data based on incipient flashing of the sample of oil while downhole in the borehole.

17. A system, comprising:
a well string comprising a sampling system deployed downhole in a wellbore, the sampling system comprising a contamination monitoring module and a microfluidic measurement module which may be operated downhole to obtain data related to FVF of oil in a surrounding reservoir; and
a processor configured to process the data to determine the FVF of the oil.

18. The system as recited in claim 17, wherein the contamination monitoring module comprises an optical spectroscopy sensor, a viscosity sensor, and a density sensor.

19. The system as recited in claim 18, wherein the microfluidic measurement module comprises a depressurization chamber.

20. The system as recited in claim 17, wherein the processor is positioned downhole as part of the well string.
